(19) United States
(12) Patent Application Publication
(10) Pub. No.: US 2009/0018970 A1
(43) Pub. Date: Jan. 15, 2009

(54) METHOD AND APPARATUS FOR IMPLEMENTING REVOLVING ASSET-BACKED SECURITIZATIONS

(75) Inventor: Frederick S. Barkman, JR., Bellevue, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: NOVELLUS CAPITAL MANAGEMENT, LLC, Bellevue, WA (US)

(21) Appl. No.: 12/177,814

(22) Filed: Jul. 22, 2008

Related U.S. Application Data
(63) Continuation of application No. 10/262,644, filed on Oct. 1, 2002, now abandoned.

(51) Int. Cl. G06Q 40/00

(52) U.S. Cl. 705/36 R; 705/37

(57) ABSTRACT

An investment system that includes a revolving asset pool for holding income-bearing assets. A manager is responsible for actively managing the asset pool by purchasing and selling assets in the pool. A tax-advantaged entity such as an LLC or a partnership owns the assets in the asset pool such that income (less costs) generated by the asset pool is all paid to the investors. The manager actively manages the assets in the asset pool by ensuring that the assets are performing adequately and by reinvesting paid principal in additional assets. A portion of the capital contributed and a portion of the income generated from the assets create reserves to pay losses on the revolving asset pool with the remainder distributed to the investors. Optionally, an insurer/financial guarantor enhances the credit quality of the assets in the revolving asset pool such that the securities backed by the assets have a minimum investment grade.

### CROSS-REFERENCE TO RELATED APPLICATION

This application is a continuation of U.S. patent application Ser. No. 10/262,644 filed Oct. 1, 2002, the disclosure of which is expressly incorporated herein by reference.

### FIELD OF THE INVENTION

The present invention relates to financial management systems in general, and in particular, to systems and methods for implementing asset-backed securitizations.

### BACKGROUND OF THE INVENTION

Securitization is a well known method of pooling together assets that produce an income stream and issuing asset-backed securities that are secured by the assets. Securitization provides a method of financing for the issuer and an investment opportunity for the investor. Securitizations can be structured with the issuer selling the assets to a trust, which then issues the securities. To enable the securities to obtain a high rating from rating agencies, the credit quality of the pool of assets is typically enhanced internally or externally (or by a combination of the two), through methods including a senior/subordinate structure, overcollateralization, insurance or financial guarantees.

One common form of securitization is the mortgage-backed securitization. These securities are well established in the marketplace. A trust issues bonds or other form of securities and purchases mortgages from the proceeds of the bonds that secure payment of the principal of and interest on the bonds. The issuer can retain a residual interest in the trust.

Mortgage-backed securities receive high credit ratings because of the type of asset involved and the fact that the securities are credit enhanced. However, the same factors that contribute to the high credit rating may make these securities less attractive to investors. Although such securities are generally considered safe, they do not usually have a high rate of return and the return is fixed with no potential for increased income if the mortgages perform well. The excess spread, which is the difference between the interest rate paid to the bond holder and the interest on the mortgages (referred to as the WAC or weighted average coupon), is used to ensure payment on the bonds if the mortgages do not perform well or is paid to the holder of the residual interest in the trust. For example, if the WAC on a pool of mortgages is 9½% and the bonds pay 6%, the 3½% excess spread is kept by the issuer/residual equity holder if the mortgages perform well, or used to make payments on the bonds if the mortgages do not perform well.

In addition, principal on the bonds is amortized, so the bond holder receives payments of both principal and interest over the life of the bond. When mortgages prepay, the bond holder receives a prepayment of the principal and no longer receives income from that principal. Therefore the bond holder must continually reinvest the principal received into other investments and may receive a lower rate of return.

Another problem with conventional mortgage-backed securities is that the bonds have a term that is the same as the underlying assets. Therefore, unless all the mortgages in the trust prepay, the bond holders can only terminate their investment by selling their bonds. In many cases, mortgages in a trust will pay off prior to the scheduled last payment but there may be some mortgages that will not. With the remaining mortgages in the trust, the bond holders will still receive payments on their bonds. However, the bonds become difficult to sell as the underlying asset pool shrinks.

Given these shortcomings, there is a need for an investment system that has the potential to offer increased returns to investors, provides for longer periods of investment of the principal and offers liquidity to investors.

### SUMMARY OF THE INVENTION

An investment system in accordance with the present invention includes a revolving asset pool into which income-bearing, preferably thinly-traded, investments are grouped. A tax-advantaged entity such as a limited liability company (LLC), partnership or real estate investment trust (REIT) owns the revolving asset pool and one or more investors have an equity interest in the tax-advantaged entity. A manager actively manages the assets in the revolving asset pool by evaluating, selecting, buying and selling assets for the pool and taking steps to ensure the performance of the assets. The system also includes credit enhancement to improve the credit quality of the underlying assets in the revolving asset pool. The credit enhancement is provided by creating loss reserves from a percentage of the capital invested and the income stream from the assets.

In one embodiment of the invention, the assets in the revolving asset pool are sub-prime mortgages. However, other types of assets such as credit card receivables, auto loans, commercial paper, second mortgages, home equity loans, or other assets bearing an interest rate that exceeds the rate at which bond holders are typically paid on investment grade bonds may be used.

Another aspect of the present invention is a security comprising an interest in a pass-through entity that holds a revolving pool of actively managed, income-bearing assets. The security entitles an owner to receive income from the assets and is credit enhanced. A portion of the capital invested and income received from the assets is held in reserve and any losses on the assets that exceed these reserves are paid by an insurer/financial guarantor. In one embodiment, income held in reserve (as credit enhancement) and not used to pay losses within a predefined period of time, is paid to owners of the security.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates a conventional system for securitizing mortgages;

FIG. 2 illustrates a revolving asset-backed securitization system in accordance with one embodiment of the present invention; and

FIG. 3 illustrates in more detail a revolving asset-backed securitization system in accordance with one embodiment of the present invention.

### DETAILED DESCRIPTION OF THE PREFERRED EMBODIMENTS

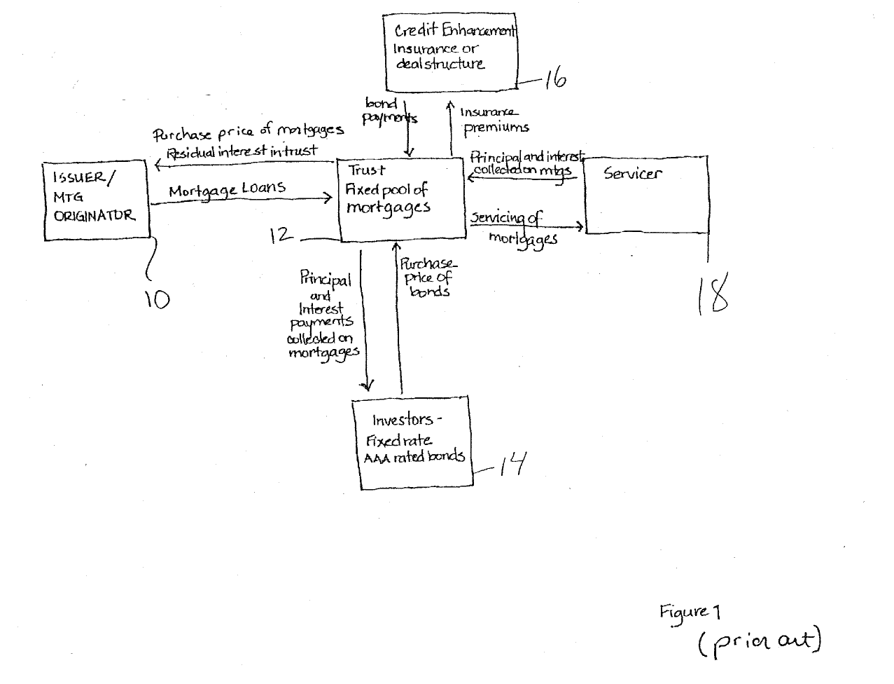

FIG. 1 illustrates the major components of a conventional system for securitizing mortgages. As indicated above, an issuer 10 creates a trust and sells mortgages to the trust 12. The trust 12 issues bonds to a number of investors 14 at a fixed percentage rate and uses the proceeds of the bonds to purchase mortgages. In addition, the issuer 10 retains a residual equity interest in the trust 12. An insurer/financial guarantor 16 is paid premiums to guarantee a return of principal and interest on the bonds, such that the bonds have a high investment grade, usually AAA or better. A servicer 18 is paid a fee to service the mortgages in the trust and to collect the principal and interest payments received from the mortgagors.

As discussed above, a conventional mortgage securitization generally requires that the interest paid by the mortgagors be split between the bond holders and the residual equity holder. For example, in the case of sub-prime mortgage securitizations, the excess spread paid to the residual equity holder can exceed 3 percentage points above the interest rate at which the bond holders are paid. Secondly, the size or composition of the assets in the trust is fixed when it is created. Therefore, as each mortgagor pays off the corresponding loan, the principal is returned to the bond holders and the asset pool of the trust upon which the interest paid to the bond holders is based is correspondingly reduced. Therefore, the bond holders must periodically reinvest their money as mortgages are paid off. Finally, as indicated above, a conventional mortgage-backed trust has a termination date that equals the maturity of the assets in the trust. Therefore, an investor cannot recover all its investment until all the mortgages in the pool are paid off or the bonds are sold.

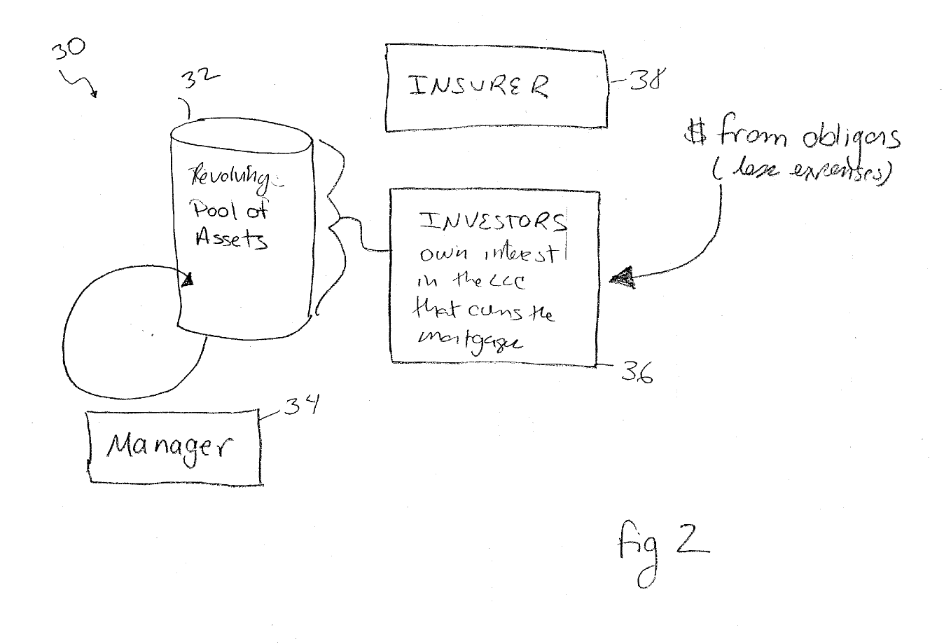

FIG. 2 illustrates a revolving asset-backed securitization system in accordance with one embodiment of the present invention. With the present invention, a financial system 30 includes a dynamic or revolving pool of assets 32. In one preferred embodiment of the invention, the assets in the pool are income bearing instruments and in yet another preferred embodiment of the invention, the assets are sub-prime mortgages. Therefore, although the present invention is described with respect to the use of sub-prime mortgages as the assets within the revolving asset pool 32, it will be appreciated that other assets such as auto loans, credit card loans, letters of credit, and commercial paper, may also be used. The invention is particularly suited for bundling “thinly-traded” assets or assets where there is no easy method of determining a market price or value. Because such assets tend to have a higher degree of risk, the interest charged on the assets is greater, thereby creating an excess spread that can be paid to investors. However, any income-bearing asset could potentially be used.

A manager 34 is paid to actively manage the pool of assets 32 by evaluating, selecting, and purchasing assets for the pool, selling assets if they are not performing as anticipated and reinvesting the principal of assets that are paid off such that the mix of assets of the asset pool 32 may be static or dynamic, depending upon market conditions and/or performance of the assets.

One or more investors 36 own an equity interest in an entity that owns the revolving asset pool 32. In one embodiment of the invention, the investors 36 own an interest in a tax-advantaged entity such as a limited liability company (LLC) that is set up to own the revolving asset pool 32. However, other tax-advantaged entities such as partnerships or REITs may be used as a vehicle for owning the revolving asset pool 32.

In at least one embodiment of the invention, an insurer/financial guarantor 38 is paid premiums to insure the performance of the assets in order to give them a particular investment grade. For example, if the assets are sub-prime mortgages, the insurer/financial guarantor is paid a premium to ensure that at least some portion of the principal and interest due on the sub-prime mortgages will be repaid.

The investment system 30 shown in FIG. 2 differs from a traditional mortgage securitization in that the pool of assets 32 is actively managed. That is, the manager 34 has the responsibility of buying and selling assets in the pool, monitoring the performance of the assets and taking steps to ensure that the assets are performing as anticipated either on its own or by contracting with others to do so. In the case of sub-prime mortgages, such steps may involve calling delinquent mortgagors, instituting foreclosure proceedings or lawsuits, or simply replacing any mortgage in the asset pool that is not performing as desired. Assets are generally reviewed by the manager for credit worthiness prior to purchase for the revolving asset pool.

In addition, if a sub-prime mortgage is paid off, the manager 34 may reinvest the principal by buying additional sub-prime mortgages such that repayments do not deplete the revolving asset pool 32. This is in contrast to conventional securitization systems whereby reinvestment of principal is not allowed or is restricted. The ability to sell assets from the pool provides investors with liquidity not possible in many conventional mortgage-backed securitizations as discussed above.

In the investment system 30 shown in FIG. 2, a potentially greater portion of the WAC may be paid from the obligors of the assets to the investors 36 without having to split the money with a bond issuer or other residual equity holder as is typically done in the conventional mortgage securitization.

When the revolving asset pool 32 contains mortgages, it was previously thought that it was not possible to have active management of the assets within the pool without creating an entity level tax such as a corporate level tax on taxable mortgage pools. A taxable mortgage pool is any entity, other than a REMIC or FASIT, (1) with substantially all of the assets consisting of debt obligations, more than half of which are real estate mortgages, (2) the entity is the obligor of debt obligations of two or more maturities, and (3) payments on the debt obligations on which the entity is obligor bear a relationship to payments on the debt obligations held as assets by the entity. It is believed that the present invention avoids an entity level tax by not meeting the second and third parts of the test.

In addition, the present invention structures the ownership of the revolving asset pool as a limited liability corporation (LLC), partnership or other tax-advantaged, pass-through entity, whereby the investors purchase equity interests in the tax-advantaged entity. Finally, in one embodiment of the invention, the equity interests in the tax-advantaged entity are sold only to qualified investors such that the investment is a security that is exempt from registration.

Another advantage of the present invention is that the asset pool 32 is continually updated with new assets and an investor can stay fully invested in the pool for a longer period of time. For example, if the asset pool contains sub-prime mortgages, such mortgages historically tend to be repaid as soon as the borrowers can qualify for loans at better rates. In contrast to prior mortgage securitization systems whereby principal paid is returned to the investors, the manager 34 uses the return of the principal to buy additional sub-prime mortgages thereby keeping the investors fully invested.

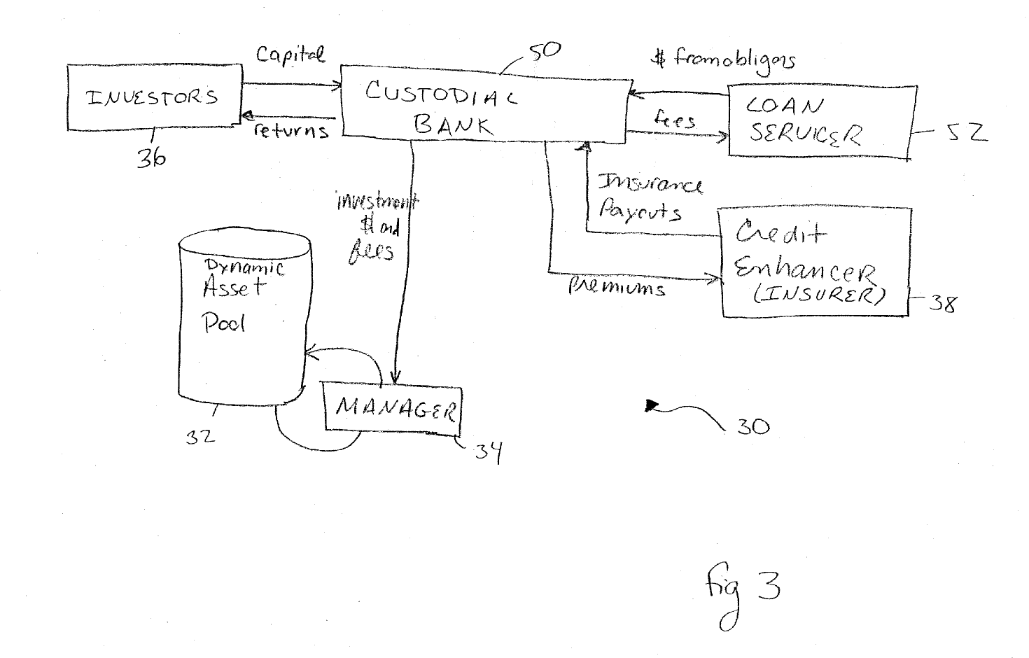

FIG. 3 shows greater detail of one embodiment of the investment system 30 for implementing revolving asset-backed securities. A custodial bank or other financial institution 50 sets up and maintains a series of accounts on behalf of the financial system 30 into and between which monies are transferred. The custodial bank 50 receives capital investments from the one or more investors 36 and maintains an income account into which returns of the investment system 30 are paid. The capital received from the investors is placed into an investment account that can be accessed by the manager 34 for the purchase and sale of assets in the revolving asset pool 32. In addition, the custodial bank 50 transfers fees to the manager 34 in return for managing the revolving asset pool 32.

A loan servicing organization 52 is hired by the manager 34 to service the assets in the revolving asset pool 32. Money from the obligors of the assets in the asset pool is received by the loan servicing organization 52 that forwards the monies to the custodial bank 50. In return, the custodial bank 50 pays the loan servicing organization 52 fees for the services rendered. In some embodiments of the invention, the manager 34 and the loan servicing organization 52 may be one in the same.

An insurer/financial guarantor 38 is paid premiums from the funds held by the custodial bank 50 in order to insure the performance of the assets in the revolving asset pool 32. The custodial bank pays the insurer/financial guarantor 38 the premiums and receives any insurance payouts on behalf of the financial system in accordance with the policy issued by the insurer/financial guarantor 38.

The particular policy issued by the insurer/financial guarantor 38 is generally a matter to be negotiated and may be dependent upon the perceived risk of the assets held in the revolving asset pool 32. In one proposed embodiment of the invention, an internal credit enhancement is provided by requiring the investors 36 to keep a percentage of their initial capital investment in a capital reserve account. In addition, a percentage of the average daily mortgage balance is held in an excess spread account to cover losses in the asset pool. In one embodiment, investors are required to keep 2% of their initial investment in the capital reserve account and annualized 5% of the average daily mortgage balance is held in the excess spread account. The internal credit enhancement allows the investment system to obtain an investment rating from a rating organization. The insurer/financial guarantor 38 requires that any losses be paid from the excess spread account and the capital reserve account before the insurer is required to pay on the credit enhancement policy. At the end of each calendar quarter, if no losses occur or there is money left in the excess spread account, the money left in the excess spread account is distributed to the investors. With the particular embodiment described above, an investor's loss is potentially capped at 2% of its initial investment and an annualized 5% of the average daily asset pool balance. The external credit enhancement allows the investment system to obtain a higher investment grade rating. In addition, by using a portion of the interest received to offset potential losses in the asset pool, the capital of investors is generally preserved, thereby allowing the pool to stay fully invested and reducing volatility in returns.

At a predefined time, which may be extendable, the investment system 30 terminates or winds down. At wind down or at the request of an investor exercising a right to liquidate a percentage of its holdings, some or all of the assets in the revolving asset pool 32 are sold on the open market. Returns from the sales (less costs, fees, etc.) are provided to the investors 36. In the case of sub-prime mortgages or other loans, it is determined whether the market will pay above or below the par value of the loans. In one embodiment of the invention, if the market will pay above the par value, the assets are sold and proceeds distributed to the investors. Disposing of the assets at a time prior to their maturity allows the investors to recoup some of the premium paid above the par value to purchase the assets initially.

If assets were sold below their par value, then it is possible that the insurer/financial guarantor will have to pay a claim on the credit enhancement policy. Therefore, in one embodiment of the invention, when loans are valued below par, the insurer/financial guarantor is allowed to control the manner, date and terms of the sale in order to recoup as much of its losses as possible. In another embodiment of the invention where there is no external credit enhancement, the manager can control the manner, date and terms of the asset disposal.

As will be appreciated, the particular terms governing the rights and responsibilities of the investors 36, the manager 34, the custodial bank 50, the loan servicing organization 58 and the insurer/financial guarantor 38, including the term of the pass-through entity, are governed by an agreement such as by an LLC agreement or other contract agreed to by all parties. Of course, the terms of such a contract may vary in accordance with the identity of the parties or the assets to be held in the revolving asset pool, or other factor.

As indicated above, although the present invention is described with respect to sub-prime mortgages as the preferred asset, it will be appreciated that other income-bearing assets could also be used. Sub-prime mortgages are one preferred asset because they carry relatively high rates of return that do not vary significantly with changing market conditions. Therefore, although the present invention has been described with respect to its preferred embodiments, those of ordinary skill in the art will recognize that changes may be made without departing from the scope of the invention. For example, as the market becomes more familiar with revolving asset-backed securitizations, the need to provide insurance as external credit enhancement insurance may lessen. Credit enhancement may be provided by a senior/subordinate structure, overcollateralization, insurance or other financial guarantees. Therefore, the scope of the invention is to be determined from the following claims and equivalents thereof.

The embodiments of the invention in which an exclusive property or privilege is claimed are defined as follows:

1. An investment system, comprising:
a revolving asset pool in which a number of income-bearing assets are held;
a tax-advantaged entity that owns the revolving asset pool;
one or more investors that have an interest in the tax-advantaged entity, each investor providing capital to purchase assets in the revolving asset pool and receiving income from the assets in the revolving asset pool;
a manager that buys and sells assets for the revolving asset pool; and
an internal credit enhancement whereby a portion of the capital contributed and a portion of the income generated from the assets create reserves to pay losses on the revolving asset pool and that increases the credit quality of the revolving asset pool.

2. The investment system of claim 1, wherein a portion of the reserves is periodically paid to the one or more investors if losses do not exceed the reserves.

3. The investment system of claim 1, further comprising an external credit enhancement whereby after the reserves for losses, the investor receives guaranteed payments determined by calculating expected return of capital and income.

4. The investment system of claim 3, wherein the external credit enhancement is provided by an insurer/financial guarantor.

5. The investment system of claim 1, wherein the manager takes steps to ensure the performance of the assets.

6. The investment system of claim 1, wherein the investors are qualified such that the investment system need not be registered.

7. The investment system of claim 1, wherein the tax-advantaged entity has a termination date that is before a maturity of the assets in the revolving asset pool.

8. The investment system of claim 1, wherein the manager can liquidate assets from the revolving asset pool upon request of an investor.

9. The investment system of claim 1, wherein income held in reserve is paid to the investors if not used to pay losses within a predefined period.

10. The investment system of claim 1, wherein the manager monitors the performance of the assets in the revolving asset pool.

11. The investment system of claim 1, wherein the income bearing assets are sub-prime mortgages.

12. The investment system of claim 1, wherein the assets are home equity loans.

13. The investment system of claim 1, wherein the assets are second mortgages.

14. The investment system of claim 1, wherein the assets are automobile loans.

15. The investment system of claim 1, wherein the assets are credit card receivables.

16. The investment system of claim 1, wherein the assets bear an interest rate that exceeds the rate at which bond holders are typically paid on investment grade bonds.

17. An investment system, comprising:
a revolving asset pool in which a number of sub-prime mortgages are held;
a pass-through entity that owns the revolving asset pool, the pass-through entity terminating before the maturation of the sub-prime mortgages in the revolving asset pool;
one or more investors that contribute capital to the pass-through entity and have an equity interest in the pass-through entity;
a manager that actively manages the sub-prime mortgages in the revolving asset pool;
wherein a portion of the capital contributed and the income received from the sub-prime mortgages is held to provide a reserve to pay losses on the revolving asset pool and the remainder is distributed to the one or more investors and repaid principal on the sub-prime mortgages is used by the manager to purchase additional sub-prime mortgages for the revolving asset pool.

18. The investment system of claim 17, wherein a portion of the reserve is periodically paid to the one or more investors if losses on the sub-prime mortgages in the revolving asset pool do not exceed the reserve.

19. The investment system of claim 17, further comprising:
an insurer/financial guarantor that ensures payment of the principal and the interest of the sub-prime mortgages after the reserve has been depleted such that the securities backed by the sub-prime mortgages have an investment grade rating.

20. The investment system of claim 17, wherein the pass-through entity is a partnership.

21. The investment system of claim 17, wherein the pass-through entity is a limited liability corporation.

22. The investment system of claim 17, wherein the pass-though entity is a real estate investment trust.

23. The investment system of claim 17, further comprising a loan servicer that services the sub-prime mortgage loans in the revolving asset pool.

24. The investment system of claim 17, wherein the manager takes steps to ensure performance of the sub-prime mortgages.

25. An investment system, comprising:
a revolving asset pool including one or more sub-prime mortgages, wherein repaid principal of the sub-prime mortgages is used to buy additional sub-prime mortgages for the asset pool;
a tax advantaged entity that owns the sub-prime mortgages in the asset pool, the tax-advantaged entity terminating before a maturation of the sub-prime mortgages in the revolving asset pool;
a plurality of qualified investors who contribute capital or assets to the tax-advantaged entity and own an interest in the tax-advantaged entity;
a manager that buys and sells sub-prime mortgages for the revolving asset pool; and
an insurer/financial guarantor that ensures payment of the sub-prime mortgages in the asset pool,
wherein a portion of the income received from the sub-prime mortgages is diverted into a reserve account to pay losses on the sub-prime mortgages and the insurer/financial guarantor pays losses on the sub-prime mortgages after the reserve account is depleted.

26. The investment system of claim 25, wherein a portion of the reserve account is periodically paid to the qualified investors if losses on the asset pool do not exceed the reserve account.

27. The investment system of claim 25, wherein the manager monitors the performance of the sub-prime mortgages in the revolving asset pool.

28. The investment system of claim 27, wherein the manager takes steps to ensure the performance of the sub-prime mortgages.

29. The investment system of claim 28, wherein the manager evaluates the sub-prime mortgages before they are purchased for the revolving asset pool.

30. A security comprising an interest in a pass-through entity that owns a revolving pool of actively managed, credit enhanced, income-bearing assets, the security granting an owner the right to receive income from the pool of assets, wherein a portion of the principal paid by the owner and income received is held as a reserve for losses of principal and interest and the credit quality of the security is increased, and wherein the pass-through entity has a termination date that is before a maturity of the income bearing assets.

31. The security of claim 30, wherein the assets are sub-prime mortgages and wherein the pass-through entity is a limited liability corporation, such that the security is an interest in the limited liability corporation.

32. The security of claim 30, wherein the security grants the owner the right to receive income held in reserve that is not used to pay losses within a predefined period of time.
